(19) United States
(12) Patent Application Publication
(10) Pub. No.: US 2017/0142494 A1
(43) Pub. Date: May 18, 2017

(54) VIDEO UPLOADING METHOD AND SYSTEM

(71) Applicants: LE HOLDINGS (BEIJING) CO., LTD., Beijing (CN); LECLOUD COMPUTING CO., LTD., Beijing (CN)

(72) Inventor: Yuhan JIANG, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,266

(22) Filed: Aug. 31, 2016

Related U.S. Application Data
(63) Continuation of application No. PCT/CN2016/083200, filed on May 24, 2016.

(30) Foreign Application Priority Data
Nov. 13, 2015 (CN) 201510780837.7

(51) Int. Cl. H04N 21/658; G06F 17/30; H04N 21/266; H04N 21/437; H04N 21/6583

(52) U.S. Cl. CPC H04N 21/6581; H04N 21/437; H04N 21/6583; H04N 21/266; G06F 17/30858

(57) ABSTRACT

A method for video uploading and an electronic device are disclosed. The method includes: storing attribute information and a selection path of a video during its uploading process, and assigning an identification (ID) number to the video selection path; if the uploading fails, labeling the video with “failure”, and generating feedback of uploading failure and a re-uploading indication; based on a received request for re-uploading the video, searching for ID numbers of videos with “failure” labels as well as attribute information and selection paths of the videos with the “failure” labels based on the retrieved ID numbers; and re-uploading the videos based on the retrieved attribute information and selection paths of the videos. The present disclosure can save users from repeatedly filling in attribute information and selection paths of videos, improve method for video uploading, reduce uploading time and improve uploading efficiency.

### CROSS REFERENCE TO RELATED APPLICATIONS

This application is a continuation of International Application No. PCT/CN2016/083200, filed on May 24, 2016, which is based upon and claims priority to Chinese Patent Application No. 201510780837.7, filed on Nov. 13, 2015, the entire contents of which are incorporated herein by reference.

### TECHNICAL FIELD

The disclosure relates to the technical field of video uploading, in particular to a method for video uploading, an electronic device and a non-transitory computer-readable storage medium.

### BACKGROUND

With the rapid changes in Internet technologies, cloud computing as an emerging technology is gradually coming into users' sight. Cloud computing takes a pay-per-use mod which can provide convenient and on-demand network resource (including networks, servers, memories, application software, etc.) access services. A user can upload shot videos to a cloud server via a client end such as a desktop, a laptop, a mobile phone or the like, or watch one of the videos from the cloud server.

FIG. 1 is a flow chart showing a method for video uploading in the prior art. As shown in FIG. 1, at present, video uploading by a user generally includes the following steps:

S101: uploading by a user a video to a server via a client end such as a desktop, a laptop, a mobile phone or the like;

S102: determining by the server whether the video is successfully uploaded or not;

S103: if the video is successfully uploaded, feeding back by the server a record that the video is successfully uploaded to the server to the client;

S104: if uploading of the video fails, feeding back by the server a record that uploading of the video fails to the client, then after the user knows that uploading of the video fails, searching by the user for an ID number of the video of which uploading fails in the server;

S105: filling in the information about the video again by the user at the client; and

S106: selecting by the user a local path of the video again before re-uploading the video.

In the prior art as mentioned above, when a user uploads a video, if the uploading fails, he or she has to spend time in looking for an ID number of the video failed to upload in a server, fill in the information about the video again, and select a local path of the video again before re-uploading the video. In such a way, not only are users' operations inconvenient, but also users' time for uploading is wasted, resulting a very low video uploading efficiency. In addition, if the staff in a professional video company upload videos to a server (such as a cloud server) in batches, the existing method for video uploading will be very inefficient. Therefore, how to improve the video uploading efficiency has become one of the industry's concerns.

### SUMMARY

The present application provides a method for video uploading, an electronic device and a non-transitory computer-readable storage medium, addressing defects of the prior art that, if uploading of a video fails, a user has to find an identification (ID) number of the video from a server, fill in the information about the video again and select the local path of the video again before re-uploading the video, which is very time-consuming.

According to an aspect of the embodiments of the present application, there is provided a method for video uploading. The method includes: during a video uploading process, storing attribute information and a selection path of the video, and assigning an identification (ID) number to the video based on the attribute information and the selection path of the video; if uploading of the video fails, labeling the video with a “failure” label, and generating feedback of uploading failure and a re-uploading indication; based on a received request for re-uploading the video, searching for ID number of the video with “failure” labels, and searching for attribute information and selection path of the video with the “failure” labels based on the ID number; and re-uploading the videos based on the retrieved attribute information and selection path of the video.

The embodiments of the present application provide another method for video uploading. The method includes: during a process in which a first video is successfully uploaded, storing attribute information and a selection path of the first video, and assigning an identification (ID) number to the first video based on the attribute information and the selection path of the first video; after receiving a request for uploading a second video having the same attribute information and selection path as those of the first video, searching for the ID number of the first video, and searching for the attribute information and the selection path of the first video based on the ID number of the first video; and uploading the second video based on the retrieved attribute information and the selection path of the first video, and assigning the ID number of the first video to the second video.

According to another aspect of embodiments of the present application, there is further provided a non-transitory computer-readable storage medium storing executable instructions that used to execute any one of methods of the present application as described above.

According to yet another aspect of the embodiments of the present application, there is further provided an electronic device, the device includes at least one processor and a memory for storing instructions executable by the at least one processor, wherein execution of the instructions by the at least one processor causes the at least one processor to execute any one of methods of the present application as described above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart showing a method for video uploading in the prior art.

FIG. 2 is a flow chart showing a method for video uploading in a first embodiment of the present application.

FIG. 3 is a flow chart showing a method for video uploading in a second embodiment of the present application.

FIG. 4 is a structure diagram of functional modules in a system for video uploading according to a first embodiment of the present application.

FIG. 5 is a structure diagram of function modules in a system for video uploading according to a second embodiment in the present application.

FIG. 6 is an architecture diagram of the method for video uploading and system provided by the embodiments of the present application.

FIG. 7 is a structure diagram of a computer system of an electronic device for realizing the embodiments of the present application.

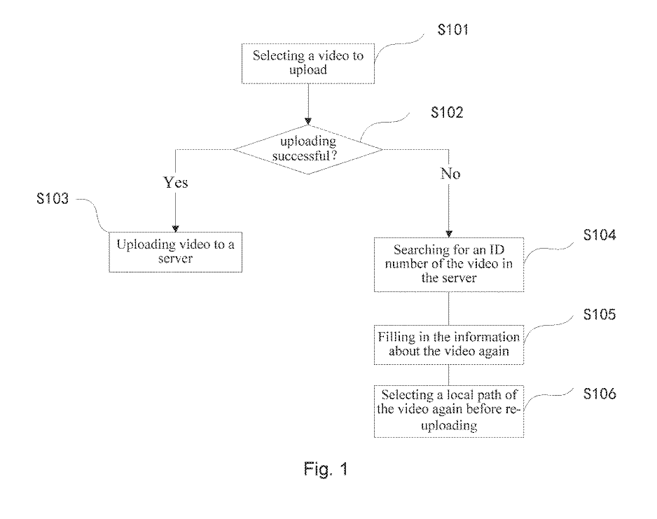

### DETAILED DESCRIPTION

In order to make the purpose, technical solutions, and advantages of the embodiments of the invention more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

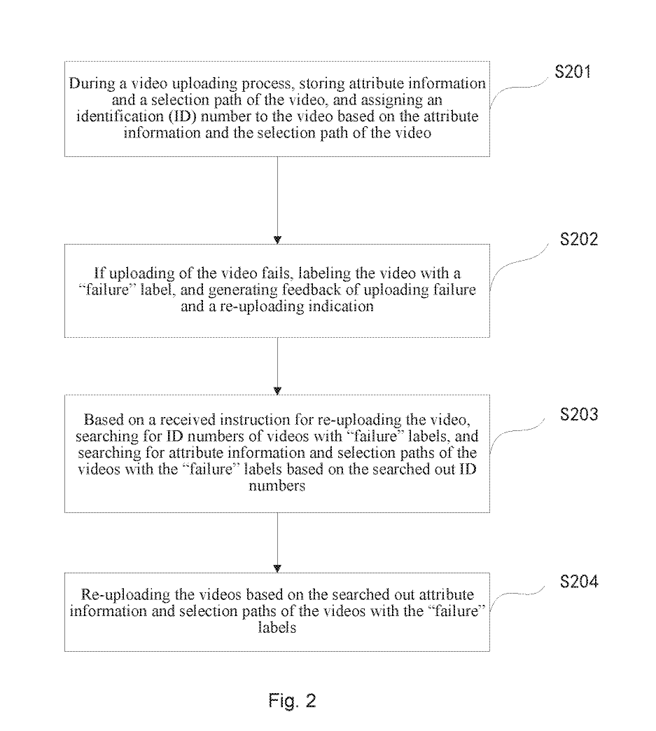

FIG. 2 is a flow chart showing a method for video uploading in a first embodiment of the present application. As shown in FIG. 2, the method for video uploading provided by the embodiments of the present application includes the following steps.

S201: during a video uploading process, attribute information and a selection path of a video are stored, and an identification (ID) number is assigned to the video based on the attribute information and the selection path of the video.

In the present embodiment, during a process that a video is uploaded to a server via a client, the server stores attribute information and a selection path of the video, and assigns an identification (ID) number (for example, 10001) to the video based on the attribute information and the selection path of the video.

In one application of the present embodiment, a user selects “Monster Hunt ” video from a laptop client end, and clicks a button of “Uploading”. Attribute information of the Monster Hunt video may include at least one of a name, a classification, a brief introduction, a title and a label, and can be stored in a data table of a server database. The data table may include fields such a storage path, the name, the classification, the brief introduction, the title, the label and the like of the video. For example, contents of the data sheet may include:

Video storage path: E:\New Folder\Film and Television Video

Video name: Monster Hunt

Video classification: Fantasy film

Brief introduction: The star-studded fantasy film, Monster Hunt, has fascinating plots, . . .

Video title: Monster Hunt, HD (High Definition)

Video label: None

In the present embodiment, a video format may adopt MPEG, MPG; DAT, PM4, 3GP, FLU, MPG or the like, which will not be restricted in the present application.

S202: if uploading of the video fails, the video is labeled with a label representing failure of uploading, for example “failure”, and feedback of uploading failure and a re-uploading indication are generated.

In the present embodiment, the feedback of uploading failure may be a dialog box indicating uploading failure of the video, or may be a voice alarm. The re-uploading indication of the server may include a video re-uploading button. The feedback of uploading failure and the re-uploading indication generated by the server may also be integrated. For instance, in a fed back dialog box, a client is informed of “Uploading of a ** video fails, re-upload or not?”, and buttons of “Yes” and “No” are given to allow a user to select. If uploading of a plurality of videos fails simultaneously, the user is also allowed to select one or more videos required to be uploaded, which will not be restricted in the present application. Meanwhile, the feedback of uploading failure and the re-uploading indication generated by the server can be in other way which anticipated by these skilled in the art, and hence are not restricted in the present application.

S203: based on a received request for re-uploading the video, ID numbers of videos with “failure” labels as well as attribute information and selection paths of the videos with the “failure” labels are retrieved based on the retrieved ID numbers.

In the present embodiment, for example, after a user clicks a video re-uploading button at a client, based on a received request for re-uploading from the client, a server searches for ID numbers (such as 10001, 10003, 1008 and the like) of videos with “failure” labels at a client thereof, and searches for attribute information and selection paths of the videos with the “failure” labels, wherein the attribute information may include a name, a classification, a brief introduction, a title, a label and the like of each video.

S204: the videos with the “failure” labels are re-uploaded based on the retrieved attribute information and selection paths thereof.

In the present application, the videos are re-uploaded based on the retrieved attribute information and selection paths of the videos with the “failure” labels as well as the re-uploading indication at the client. Wherein, during re-uploading, the whole Monster Hunt video can be re-uploaded to cover part of uploaded video, or re-uploading of the video can be continued from an interrupted part. For example, if in the first time of uploading of the Monster Hunt video, uploading is interrupted at the half of the video, then only the remaining half of the video is required to be re-uploaded for re-uploading. Thus, the user can continue uploading the video from the interrupted point according to the present embodiment, which saves time for next uploading thus greatly improving the video uploading efficiency.

In an alternative embodiment of the present application, after a video is successfully uploaded or uploading of the video fails for a predetermined period (for example, one month), a server deletes stored attribute information, the selection path and the ID number. Thus, in the present embodiment, a storage space can be saved as the server regularly deletes unnecessary files to make programs run faster.

In other alternative embodiments of the present application, a user can upload a video to a cloud server via a client such as a desktop, a laptop, a mobile phone or the like, or can upload the video to a PC or other servers. The server may include a server or a server cluster, which will not be restricted in the present application.

As mentioned above, in the embodiments of the present application, by conducting a top-level design through change of a framework structure of a data table in a server database and storage of attribute information and selection paths of videos by a server, users are saved from repeatedly filling in the attribute information and selection paths of the videos, so that method for video uploadings are optimized, the video uploading time is reduced, and the video uploading efficiency is improved.

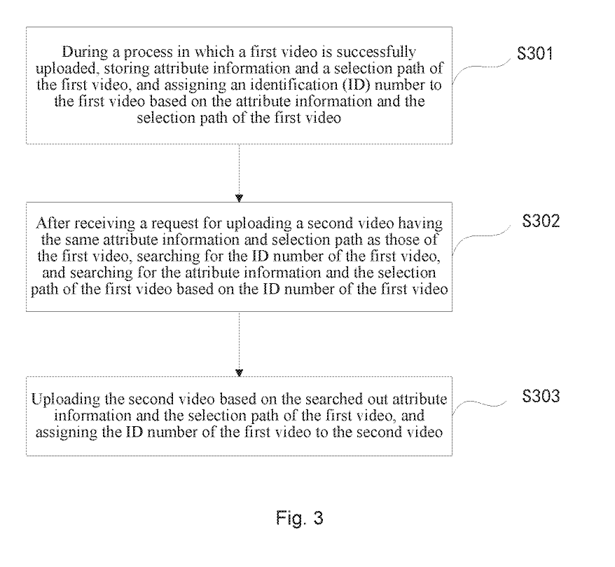

FIG. 3 is a flow chart showing a method for video uploading in a second embodiment of the present application. As shown in FIG. 3, the method for video uploading provided by the embodiments of the present application includes the following steps.

S301: during a process in which a first video is successfully uploaded, attribute information and a selection path of the first video are stored, and an identification (ID) number is assigned to the first video based on the attribute information and the selection path of the first video.

In the present embodiment, during a process that a first video is successfully uploaded to a server by a client, the server stores attribute information and a selection path of the first video, and assigns an identification (ID) number to the first video based on the attribute information and the selection path of the first video. Wherein, the first video may be one or more videos, which will not be restricted in the present application.

S302: after receiving a request for uploading a second video having the same attribute information and selection path as those of the first video, the ID number of the first video is retrieved, and the attribute information and the selection path of the first video are retrieved based on the ID number.

In the present embodiment, after a server receives a request for uploading the second video having the same attribute information and selection path as those of the first video sent by a client, the server searches for the ID number of the first video from a database thereof, and searches for the attribute information and the selection path of the first video based on the ID number.

S303: the second video is uploaded based on the retrieved attribute information and the selection path of the first video, and the ID number of the first video is assigned to the second video to replace the first video with the second video.

In the present embodiment, a server uploads the second video based on the retrieved attribute information and the selection path of the first video as well an uploading request of a client, and assigns the ID number of the first video to the second video to replace the first video with the second video.

In the embodiments of the present application, attribute information, selection paths and the like which are the same as those described in the first embodiment will not be repeated, but only difference between the first and second embodiments will be illustrated herein. In some alternative embodiments, the first video may be a low bit rate video, such as a common Monster Hunt video, and the second video can be a high bit rate video, such as a high-definition Monster Hunt video.

In an alternative embodiment of the present application, when videos are uploaded via a client in batches, after transmission of all the videos is completed, a server generates a dialog box indicating uploading failure and a “re-uploading” button on an operation interface of the client, and the server can re-upload all the videos or part of the videos based on a selection from the dialog box. Therefore, according to the present embodiment, after the videos are uploaded in batches, all the videos are re-uploaded or only videos failed to upload are re-uploaded, so that user operations are optimized and the video uploading efficiency is improved.

In other alternative embodiments of the present application, after a video is successfully uploaded or fails to be uploaded for a predetermined period, the stored attribute information, the selection path and the ID number can be deleted from the server. Thus, in the embodiments of the present application, a storage space can be saved as the server regularly deletes unnecessary files to make programs run faster.

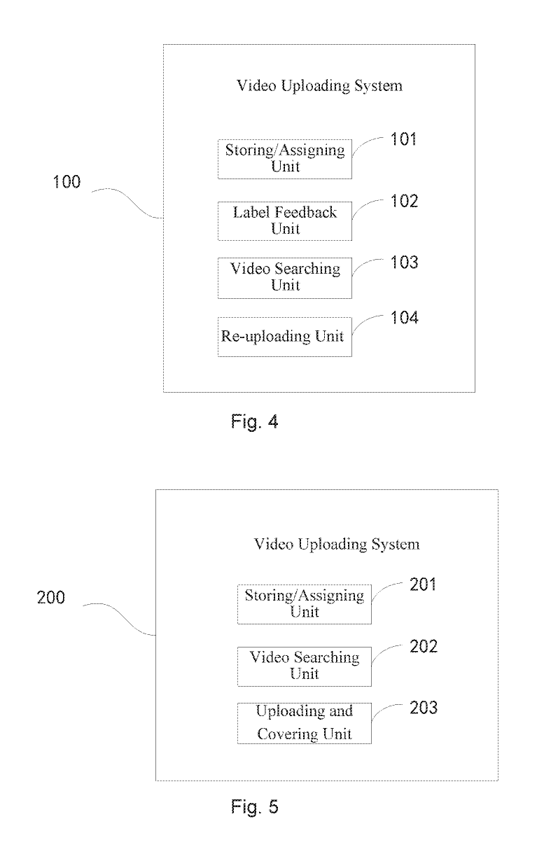

FIG. 4 is a structure diagram of function modules in a system for video uploading according to a first embodiment of the present application. As shown in FIG. 4, the system for video uploading 100 in the present embodiment includes a storing/assigning unit 101, a label feedback unit 102, a video searching unit 103 and a re-uploading unit 104.

In the present embodiment, the system for video uploading 100 may be a server or a server cluster, the storing/assigning unit 101, the label feedback unit 102, the video searching unit 103 and the re-uploading unit 104 may be coherent processing units in the server, or one or more servers in the server cluster, which is not restricted in the present application.

The storing/assigning unit 101 is configured to, during a video uploading process, store attribute information and a selection path of the video, and assign an identification (ID) number to the video based on the attribute information and the selection path of the video.

The label feedback unit 102 is configured to, if uploading of the video fails, label the video with a “failure” label, and generate feedback of uploading failure and a re-uploading indication.

The video searching unit 103 is configured to, based on a received request for re-uploading the video, search for ID numbers of videos with “failure” labels, and search for attribute information and selection paths, stored in the storing/assigning unit 101, of the videos with the “failure” labels based on the retrieved ID numbers.

The re-uploading unit 104 is configured to re-upload the videos based on the retrieved attribute information and selection paths retrieved by the video searching unit 103, of the videos with the “failure” labels.

The attribute information related in the present embodiment may include at least one of a name, a classification, a brief introduction, a title and a label of the video.

FIG. 5 is a structural diagram of function modules in a system for video uploading according to a second embodiment of the present application. As shown in FIG. 5, a system for video uploading 200 may include a storing/assigning unit 201, a video searching unit 202 and an uploading and covering unit 203.

In the present embodiment, the system for video uploading 200 may be a server or a server cluster, the storing/assigning unit 201, the video searching unit 202 and the uploading and covering unit 203 may be related processing units in the server, or one or more servers in the server cluster, which is not restricted in the present application.

The storing/assigning unit 201 is configured to, during a process in which a first video is successfully uploaded, store attribute information and a selection path of the first video, and assign an identification (ID) number to the first video based on the attribute information and the selection path of the first video.

The video searching unit 202 is configured to, after receiving a request for uploading a second video having the same attribute information and selection path as those of the first video, search for the ID number of the first video, and search for the attribute information and the selection path, stored in storing/assigning unit 201, of the first video based on the ID number of the first video.

The uploading and covering unit 203 is configured to, upload the second video based on the attribute information and the selection path, retrieved by the video searching unit 202, of the first video, and assign the ID number of the first video to the second video.

In the present embodiment, the first video is a low code rate video, and the second video is a high code rate video. Or, other types of videos can be chosen to replace the low and high code rate videos according to the actual needs.

The system for video uploading provided by the embodiments of the present application further includes a buffering and processing unit configured to, after a video is successfully uploaded or uploading of the video fails for a predetermined period, delete the stored attribute information and the selection path and the ID number.

It should be understood that the all units described in FIGS. 4 and 5 correspond to the all steps described in FIGS. 2 and 3. Thus, operations and features described in the above methods as well as correspondingly technical effects are also applicable to the all units described in FIGS. 4 and 5, and descriptions thereof will not be repeated herein.

It is worth noting that the units in the embodiments of the present application are not intended to limit the scheme of the present application, for example, the re-uploading unit can be described as the video uploading unit for uploading the video based on the retrieved attribute information and selection path.

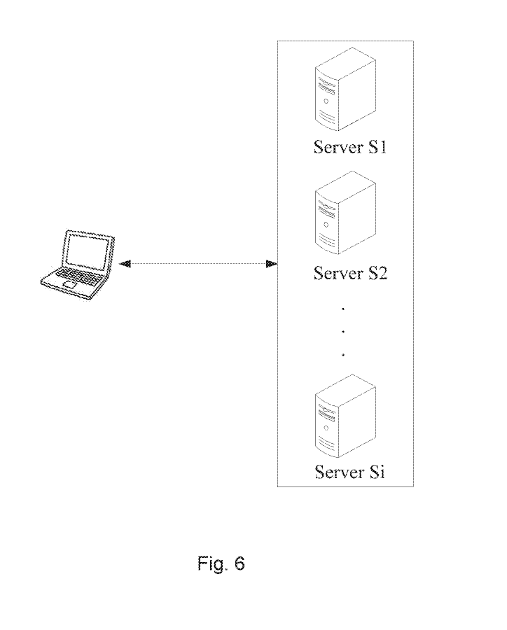

FIG. 6 is an architecture diagram of a method for video uploading and system provided by the embodiments of the present application.

Referring to FIG. 6, the architecture diagram of the method for video uploading and system provided by the embodiments of the present application includes a terminal C and servers S1, S2 . . . , and Si, wherein one or more servers are included, each server may include one or more processing units, or a plurality of servers form a processing unit, which will not be limited in the present application.

In one embodiment of the present application, the terminal C uploads a video file to a server, and the server stores attribute information and a selection path of the video file uploaded by the terminal C, and assigns an ID number to the video file. If the terminal C fails to upload the video file, the server re-uploads the video file according to the stored attribute information and selection path. By using the server to re-upload the video file based on the stored attribute information and selection path, the present embodiment eliminates an operation step of repeatedly filling in the attribute information and selection path of the video, optimizes method for video uploadings, reduces the video uploading time and improves the video uploading efficiency.

In another embodiment of the present application, during a process that a first video is successfully uploaded to a server via the terminal C, the server stores attribute information and a selection path of the first video, and assigns an identification (ID) number to the first video based on the attribute information and the selection path of the first video. When receiving a request for uploading a second video, having the same attribute information and selection path as those of the first video, sent by the terminal, the server searches for the ID number of the first video from a database thereof, and searches for the attribute information and the selection path of the first video based on the ID number. The server uploads the second video based on the retrieved attribute information and selection path of the first video, and assigns the ID number of the first video to the second video to replace the first video with the second video. Therefore, according to the present embodiment, after the videos are uploaded in batches, all the videos are re-uploaded or only videos failed to upload are re-uploaded, so that user operations are optimized and the video uploading efficiency is improved.

In the embodiments of the present application, all functions of coherent function modules can be implemented by a hardware processor and respective units.

An embodiment of the present application also provides a non-transitory computer-readable storage medium storing executable instructions that used to execute any one of methods of the present application as described above.

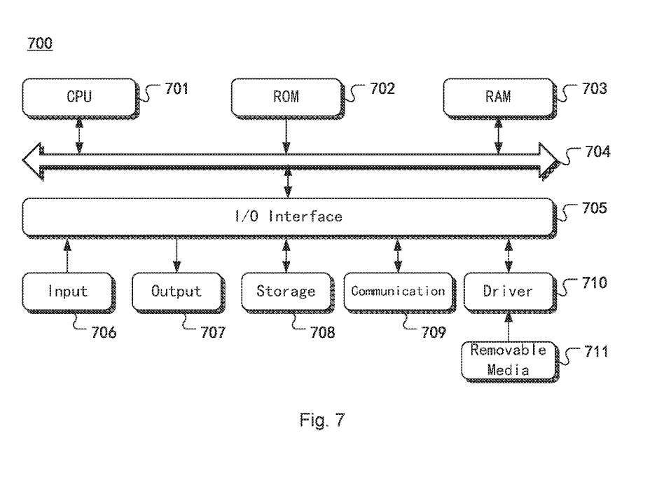

Further, FIG. 7 is a structure diagram of a an electronic device for realizing the embodiments of the present application.

As shown in FIG. 7, the electronic device includes a central processing unit (CPU) 701 which can perform various appropriate actions and processing according to a program stored in a read-only memory (ROM) 702 or a program loaded to a random access memory (RAM) 703 from a storing part 708. Various programs and data required during operation of the system are also stored in the RAM 703. The CPU 701, the ROM 702 and the RAM 703 are connected with one another via a bus 704. An Input/Output (I/O) interface 705 is also connected to the bus 704.

Components connected to the Input/Output (I/O) interface 705 includes an input portion 706 including a keyboard, a mouse and the like, an output portion 706 including such as a cathode ray tube (CRT), a liquid crystal display (LCD) and a speaker, the storage portion 708 including hardware and the like, and a communication portion 709 of a network interface card including an LAN card, a modem, etc. The communication portion 709 performs communication processing via a network such as the Internet. A driver 710 is connected to the Input/Output (I/O) interface 705 as required. A removable medium 711 such as a magnetic disk, an optical disk, a magneto-optical disk or a semiconductor memory is installed on the driver 710 as required so as to enable a computer program read out from the removable medium 711 to be installed into the storage portion 708 according to the needs.

Particularly, according to the embodiments of the present application, the steps described in the above reference flow chart can be implemented as a computer software program. For example, the embodiments of the present application include a computer program product including a computer program which is tangibly contained in a machine-readable medium, and the computer program includes a program code for performing the method as shown in the flow chart. In such embodiments, the computer program can be downloaded and installed from the network via the communication portion 709, and/or can be installed from the removable medium 711.

Computer operation instructions may be stored in a read-only memory (ROM) 602 or loaded from a storage portion 608 to a random access memory (RAM) 603.

A processor is configured to execute computer operation instructions stored in storage means, so as to execute the following steps:

during a video uploading process, storing attribute information and a selection path of the video, and assigning an identification (ID) number to the video based on the attribute information and the selection path of the video;

if uploading of the video fails, labeling the video with a “failure” label, and generating feedback of uploading failure and a re-uploading indication;

based on a received request for re-uploading the video, searching for ID numbers of videos with “failure” labels, and searching for attribute information and selection paths of the videos with the “failure” labels based on the retrieved ID numbers; and

re-uploading the videos based on the retrieved attribute information and selection paths of the videos with the “failure” labels.

Or, the processor is configured to execute the computer operation instructions stored in each server, so as to execute the following steps:

during a process in which a first video is successfully uploaded, storing attribute information and a selection path of the first video, and assigning an identification (ID) number to the first video based on the attribute information and the selection path of the first video;

after receiving a request for uploading a second video having the same attribute information and selection path as those of the first video, searching for the ID number of the first video, and searching for the attribute information and the selection path of the first video based on the ID number of the first video; and

uploading the second video based on the retrieved attribute information and selection path of the first video, and assigning the ID number of the first video to the second video.

The above described embodiments of the devices are merely illustrative, wherein the all units described as separate components may be or may not be physically separated, and components named as units may be or may not be physical units. That is, the components can be located at a place, or distributed to multiple network elements. According to actual needs, part of or all of the modules can be selected to realize purposes of the embodiments of the present application. Those of ordinary skill in the art can understand and implement it without carrying out any creative work.

Through the descriptions of the above embodiments, those skilled in the art can clearly know that the all embodiments can be implemented by software with a necessary universal hardware platform, and of course, also can be implemented by hardware. Based on this understanding, naturally, the above technical schemes or the contribution to the prior art may be embodied as a software product. The computer software product may be stored in a computer readable storage medium, such as an ROM/RAM, a magnetic disc, an optical disc or the like, and may include a plurality of instructions allowing a computer device (a personal computer, a server, or network equipment) to execute methods described by all or part of the embodiments.

At last, it should be noted that the above embodiments are merely provided for describing the technical schemes of the present application, but not intended to limit the same. Although the present application has been described in detail with reference to the above embodiments, those skilled in the art will appreciate that the technical schemes described in the above embodiments may be modified, or part of technical features in the embodiments may be replaced with equivalents without departing from the spirits and scopes of the technical schemes of the all embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A method for video uploading, comprising: at an electronic device,
during a video uploading process, storing attribute information and a selection path of the video, and assigning an identification (ID) number to the video based on the attribute information and the selection path of the video;
if uploading of the video fails, labeling the video with a “failure” label, and generating feedback of uploading failure and a re-uploading indication;
based on a received request for re-uploading the video, searching for ID numbers of videos with “failure” labels, and searching for attribute information and selection paths of the videos with the “failure” labels based on the ID numbers retrieved; and
re-uploading the videos based on the attribute information retrieved and the selection paths of the videos.

2. The method of claim 1, wherein the attribute information comprises at least one of a name, a classification, a brief introduction, a title and a label of the video.

3. The method of claim 1, further comprising:
searching for the ID number of a first video after receiving a request for uploading a second video which has the same attribute information and selection path as those of the first video, and searching for the attribute information and the selection path of the first video based on the ID number of the first video.

4. The method of claim 1, further comprising:
uploading a second video based on the attribute information retrieved and the selection path of a first video, and assigning the ID number of the first video to the second video.

5. The method of claim 4, wherein the first video is a low code rate video, and the second video a high code rate video.

6. The method of claim 4, further comprising:
deleting the stored attribute information and the selection path and the ID number after a video is successfully or unsuccessfully uploaded for a predetermined period.

7. A non-transitory computer-readable storage medium storing executable instructions that, when executed by an electronic device, cause the electronic device to:
store attribute information and a selection path of a video during a video uploading process, and assign an identification (ID) number to the video based on the attribute information and the selection path of the video;
label the video with a “failure” label if uploading of the video fails, and generate feedback of uploading failure and a re-uploading indication;
search for ID numbers of videos with “failure” labels based on a received request for re-uploading the video, and search for attribute information and selection paths of the videos with the “failure” labels based on the ID numbers retrieved; and
re-upload the videos based on the attribute information retrieved and selection paths of the videos with the “failure” labels.

8. The non-transitory computer-readable storage medium of claim 7, wherein executable instruction, when executed by an electronic device, cause the electronic device to:
store attribute information and a selection path of a first video during a process in which a first video is successfully uploaded, and assign an identification (ID) number to the first video based on the attribute information and the selection path of the first video; ; and
after receiving a request for uploading a second video having the same attribute information and selection path as those of the first video, search for the ID number of the first video, and search for the attribute information and the selection path of the first video based on the ID number of the first video.

9. The non-transitory computer-readable storage medium of claim 8, wherein executable instruction, when executed by an electronic device, further cause the electronic device to upload the second video based on retrieved attribute information and the selection path of the first video, and assign the ID number of the first video to the second video.

10. The non-transitory computer-readable storage medium of claim 8, wherein the attribute information comprises at least one of a name, a classification, a brief introduction, a title and a label of the video.

11. The non-transitory computer-readable storage medium of claim 8, wherein the first video is a low code rate video, and the second video a high code rate video.

12. The non-transitory computer-readable storage medium of claim 11, wherein the executable instructions, when executed by an electronic device, further cause the electronic device to: delete the attribute information stored and the selection path and the ID number after the video is successfully uploaded, or unsuccessfully uploaded for a predetermined period.

13. An electronic device, comprising:
at least one processor; and
a memory communicably connected with the at least one processor for storing instructions executable by the at least one processor, wherein execution of the instructions by the at least one processor causes the at least one processor to:
during a video uploading process, store attribute information and a selection path of a video, and assign an identification (ID) number to the video based on the attribute information and the selection path of the video;
if uploading of the video fails, label the video with a “failure” label, and generate feedback of uploading failure and a re-uploading indication;
based on a received request for re-uploading the video, search for ID numbers of videos with “failure” labels, and search for attribute information and selection paths of the videos with the “failure” labels based on retrieved ID numbers; and
re-upload the videos based on retrieved attribute information and selection paths of the videos with the “failure” labels.

14. The electronic device of claim 13, wherein execution of the instructions by the at least one processor causes the at least one processor to:
during a process in which a first video is successfully uploaded, store attribute information and a selection path of the first video, and assign an identification (ID) number to the first video based on the attribute information and the selection path of the first video;
after receiving a request for uploading a second video having the same attribute information and selection path as those of the first video, search for the ID number of the first video, and search for the attribute information and the selection path of the first video based on the ID number of the first video.

15. The electronic device of claim 14, wherein execution of the instructions by the at least one processor further causes the at least one processor to upload the second video based on the retrieved attribute information and the selection path of the first video, and assign the ID number of the first video to the second video.

16. The electronic device of claim 13, wherein the attribute information comprises at least one of a name, a classification, a brief introduction, a title and a label of the video.

17. The electronic device of claim 14, wherein the first video is a low code rate video, and the second video a high code rate video.

18. The electronic device of claim 13, wherein after a video is successfully or unsuccessfully for a predetermined period, execution of the instructions by the at least one processor causes the at least one processor further to delete the attribute information stored and the selection path and the ID number.
